(19) United States
(12) Patent Application Publication
(10) Pub. No.: US 2023/0243748 A1
(43) Pub. Date: Aug. 3, 2023

(54) APPARATUS FOR MEASURING OPTOFLUIDIC DROPLET FLUORESCENCE AND MANUFACTURING METHOD THEREOF

(71) Applicant: ELECTRONICS AND TELECOMMUNICATIONS RESEARCH INSTITUTE, Daejeon (KR)

(72) Inventor: Jin Tae KIM, Daejeon (KR)

(73) Assignee: ELECTRONICS AND TELECOMMUNICATIONS RESEARCH INSTITUTE, Daejeon (KR)

(21) Appl. No.: 17/988,036

(22) Filed: Nov. 16, 2022

(30) Foreign Application Priority Data
Feb. 3, 2022 (KR) 10-2022-0014046

(51) Int. Cl. G01N 21/64

(52) U.S. Cl. CPC G01N 21/6428; G01N 21/6486; G01N 2800/52

(57) ABSTRACT

Disclosed herein an device for measuring optofluidic droplet fluorescence and manufacturing method thereof. The device includes: a fluorescence excitation unit configured to reflect and output a fluorescence-exciting light, which is applied in a horizontal direction, in an upward direction; and a fluorescence measurement unit that is physically coupled with the fluorescence excitation unit and receives the fluorescence and measures fluorescence of the optofluidic droplet when fluorescence is generated from an optofluidic droplet by the fluorescence-exciting light that is input from downward direction.

### CROSS REFERENCE TO RELATED APPLICATION

The present application claims priority to a Korean application 10-2022-0014046, filed Feb. 3, 2022, the entire contents of which are incorporated herein for all purposes by this reference.

### BACKGROUND OF THE INVENTION

### Field of the Invention

The present disclosure relates to an apparatus for measuring optofluidic droplet fluorescence and a method for manufacturing the apparatus and, more particularly, to an apparatus for measuring digital PCR optofluidic droplet fluorescence and a method for manufacturing the apparatus.

### Description of the Related Art

Polymerase chain reaction (PCR) is a technique of exponentially amplifying a nucleic acid with a specific sequence by repeatedly heating and cooling a sample solution containing the nucleric acid and successively copying a region with the specific sequence of the nucleric acid, and the technique may be implemented by a series of specific temperature enzyme reaction steps like denaturation, annealing and extension.

At the first step of denaturation, two strands of DNA are heated and separated. Each DNA thus separated becomes a template.

At the second step of annealing, primers are bound to the template DNA. At this annealing step, since the temperature is a critical factor that determines the accuracy of reaction, if the temperature is too high, a primer is bound to the template DNA so weakly that there is only a small amount of amplified DNA. In addition, if the temperature is set too low, non-specific binding of primer may amplify unwanted DNA.

At the third step of extension, a heat-resistant DNA polymerase makes new DNA from the template DNA.

In recent years, as the digital PCR technique is highlighted as the advanced 3rd generation PCR technique, more accurate testing becomes possible. However, there are obstacles to the dissemination of digital PCR, since the current digital PCR devices require that various types of equipment are used for testing or an expensive micro well chip is fabricated, and the preparation also implies inconvenience and many sensitivities. Furthermore, complicated procedures and methods increase the expense of testing equipment, which is another big obstacle to introducing the digital PCR.

### SUMMARY

The present disclosure is technically directed to provide an apparatus for measuring digital PCR optofluidic droplet fluorescence and a method for manufacturing the apparatus.

The technical objects of the present disclosure are not limited to the above-mentioned technical objects, and other technical objects that are not mentioned will be clearly understood by those skilled in the art through the following descriptions.

According to the present disclosure, there is provided a device for measuring optofluidic droplet fluorescence, the device comprising: a fluorescence excitation unit configured to reflect and output a fluorescence-exciting light, which is applied in a horizontal direction, in an upward direction; and a fluorescence measurement unit that is physically coupled with the fluorescence excitation unit and receives the fluorescence and measures fluorescence of the optofluidic droplet when fluorescence is generated from an optofluidic droplet by the fluorescence-exciting light that is input from downward direction.

According to the embodiment of the present disclosure in the device, the fluorescence excitation unit may comprise: an excitation channel into which a first optical fiber for applying the fluorescence-exciting light is inserted by etching at least a part of a substrate; and a reflection means that is formed at an end of the excitation channel and reflects the fluorescence-exciting light in an upward direction.

According to the embodiment of the present disclosure in the device, the excitation channel may be formed in a ‘V’ shape.

According to the embodiment of the present disclosure in the device, the reflection means may be formed in part of regions including an end of the excitation channel that has a predetermined angle.

According to the embodiment of the present disclosure in the device, a width and a depth of the excitation channel may be determined by a diameter of the first optical fiber.

According to the embodiment of the present disclosure in the device, the fluorescence excitation unit may comprise a first coupling unit that is formed in at least one region of the substrate. The fluorescence measurement unit may comprise a second coupling unit that is formed at a position corresponding to the first coupling unit and with a shape corresponding to a shape of the first coupling unit so that the fluorescence measurement unit is capable of being physically coupled with the fluorescence excitation unit.

According to the embodiment of the present disclosure in the device, the fluorescence measurement unit further may comprise: a fluidic channel in which the optofluidic droplet flows; and a first optical channel that is formed by being spaced at a predetermined distance from the fluidic channel by a first partition, a second optical fiber for receiving fluorescence generated from the optofluidic droplet being inserted into the first optical channel.

According to the embodiment of the present disclosure in the device, the first optical channel may be formed in a orthogonal direction to a part of the fluidic channel into which the fluorescence-exciting light is input.

According to the embodiment of the present disclosure in the device, the fluorescence measurement unit further may comprise a second optical channel that is formed by being spaced at a predetermined distance from the fluidic channel by a second partition, a third optical fiber for receiving fluorescence generated from the optofluidic droplet being inserted into the second optical channel.

According to the embodiment of the present disclosure in the device, the first optical channel and the second optical channel may be formed to have a predetermined angle in different directions with respect to the fluidic channel.

According to the embodiment of the present disclosure in the device, the device may further comprise a spacer that is formed between the fluorescence measurement unit and the fluorescence excitation unit and maintains a predetermined space between the fluorescence measurement unit and the fluorescence excitation unit.

According to another embodiment of the present disclosure, there is provided a device for measuring optofluidic droplet fluorescence, the device comprising: a fluorescence excitation unit configured to reflect and output in an upward direction each of fluorescence-exciting lights with different wavelengths, which are applied respectively in a horizontal direction; and a fluorescence measurement unit that a fluorescence-exciting light with a wavelength corresponding to each of a plurality of regions of a fluidic channel. which an optofluidic droplet flows, is input into from downward direction, receives fluorescence generated from an optofluidic droplet in each of the plurality of regions and measures the fluorescence of the optofluidic droplet.

According to the embodiment of the present disclosure in the device, the fluorescence excitation unit may comprises: a plurality of excitation channels into which each optical fiber for applying each of the fluorescence-exciting lights is inserted by etching at least a part of a substrate; and a plurality of reflection means that are formed at an end of each of the excitation channels and reflect each of the fluorescence-exciting lights in an upward direction.

According to the embodiment of the present disclosure in the device, the fluorescence measurement unit may further comprise: a fluidic channel in which the optofluidic droplet flows; and a plurality of optical channels that are formed by being spaced at a predetermined distance from each of a plurality of regions of the fluidic channel by a partition, each optical fiber for receiving fluorescence generated from the optofluidic droplet being inserted into the plurality of optical channels.

According to the embodiment of the present disclosure in the device, the device may further comprise a spacer that is formed between the fluorescence measurement unit and the fluorescence excitation unit and maintains a predetermined space between the fluorescence measurement unit and the fluorescence excitation unit.

According to the embodiment of the present disclosure in the device, the plurality of excitation channels may be perpendicular to the fluidic channel and are formed in parallel in one side direction of the fluidic channel or are formed to cross each other in one side direction and in another side direction respectively for the fluidic channel.

According to the embodiment of the present disclosure in the device, the plurality of optical channels may be perpendicular to the fluidic channel and are formed in parallel in one side direction of the fluidic channel or are formed to cross each other in one side direction and in another side direction respectively for the fluidic channel.

According to another embodiment of the present disclosure, there is provided a method for manufacturing an optofluidic droplet fluorescence measurement device, the method comprising: forming a first structure by forming an excitation channel, into which a first optical fiber for applying a fluorescence-exciting light is inserted by etching at least a part of a substrate, and by depositing, in at least part of regions including an end of the excitation channel, a reflection layer for reflecting the fluorescence-exciting light in an upward direction; forming a second structure that includes a fluidic channel, in which an optofluidic droplet flows, and an optical channel into which a second optical fiber for receiving fluorescence generated from the optofluidic droplet is inserted; and coupling the first structure and the second structure in alignment.

According to the embodiment of the present disclosure in the method, the forming of the second structure may comprise: forming a channel layer for forming the fluidic channel and the optical channel on a first substrate; forming a polydimethylsiloxane (PDMS) layer with a predetermined thickness on the first substrate including the channel layer; and forming the second structure by separating the PDMS layer from the first substrate.

According to the embodiment of the present disclosure in the method, the coupling in alignment may couple the first structure and the second structure in alignment by using a spacer for maintaining a predetermined space between the first structure and the second structure.

The features briefly summarized above for this disclosure are only exemplary aspects of the detailed description of the disclosure which follow, and are not intended to limit the scope of the disclosure.

According to the present disclosure, it is possible to provide an apparatus for measuring digital PCR optofluidic droplet fluorescence and a method for manufacturing the apparatus.

According to the present disclosure, in droplet digital PCR (ddPCR), after polymerase chain reaction, a droplet fluorescence measuring device for measuring fluorescence properties of unit droplets may be provided so that the presence of biomaterial (DNA or RNA) can be checked precisely and accurately.

The technical problems solved by the present disclosure are not limited to the above technical problems and other technical problems which are not described herein will be clearly understood by a person (hereinafter referred to as an ordinary technician) having ordinary skill in the technical field, to which the present disclosure belongs, from the following description.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a perspective view illustrating an optofluidic droplet fluorescence measuring device according to an embodiment of the present disclosure.

FIG. 2 is a view illustrating a process of coupling a fluorescence excitation unit and a fluorescence measurement unit in a device of the present disclosure.

FIG. 3 is a perspective view illustrating a fluorescence excitation unit and a fluorescence measurement unit coupled to each other in a device of the present disclosure.

FIG. 4 is a view illustrating A-B of FIG. 2 in section.

FIG. 5 is a view illustrating A′-B′ of FIG. 3 in section.

FIGS. 6A and 6B are views for describing an operation of an optofluidic droplet fluorescence measuring device of the present disclosure.

FIG. 7 is a view illustrating an embodiment for a measurement result of an optofluidic droplet fluorescence measuring device of the present disclosure.

FIG. 8 is a view illustrating another embodiment of a fluorescence measurement unit.

FIG. 9 is a view illustrating yet another embodiment of a fluorescence measurement unit.

FIG. 10 is a perspective view illustrating an optofluidic droplet fluorescence measuring device according to another embodiment of the present disclosure.

FIG. 11 is a perspective view illustrating an optofluidic droplet fluorescence measuring device according to yet another embodiment of the present disclosure.

FIG. 12 is a view illustrating a flowchart of a manufacturing method for an optofluidic droplet fluorescence measuring device according to an embodiment of the present disclosure.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, ““at Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

The main idea of the present disclosure is to measure fluorescence properties of unit droplets after polymerase chain reaction.

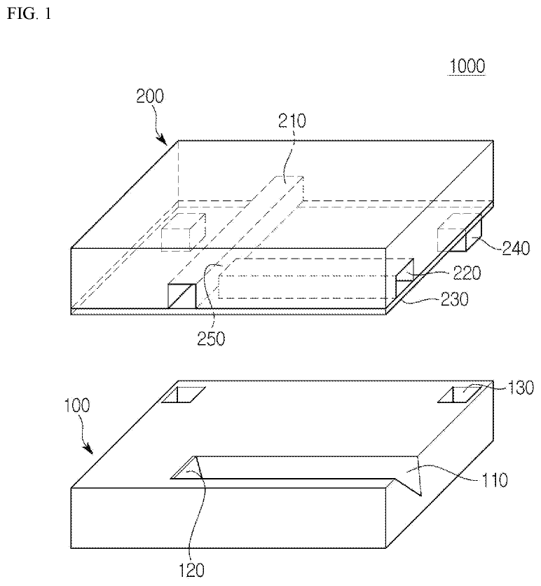

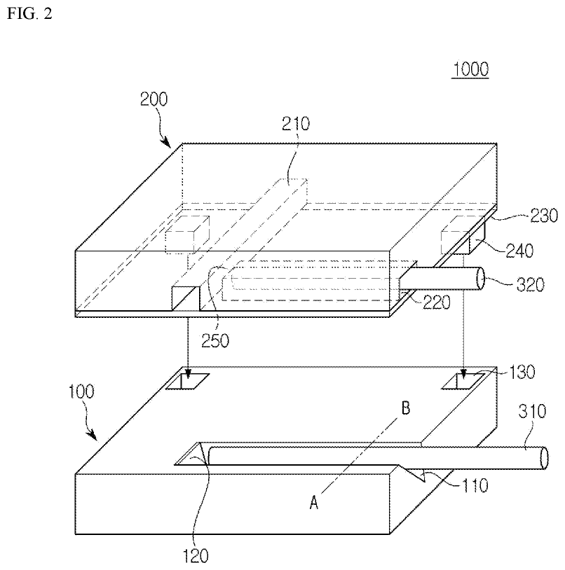

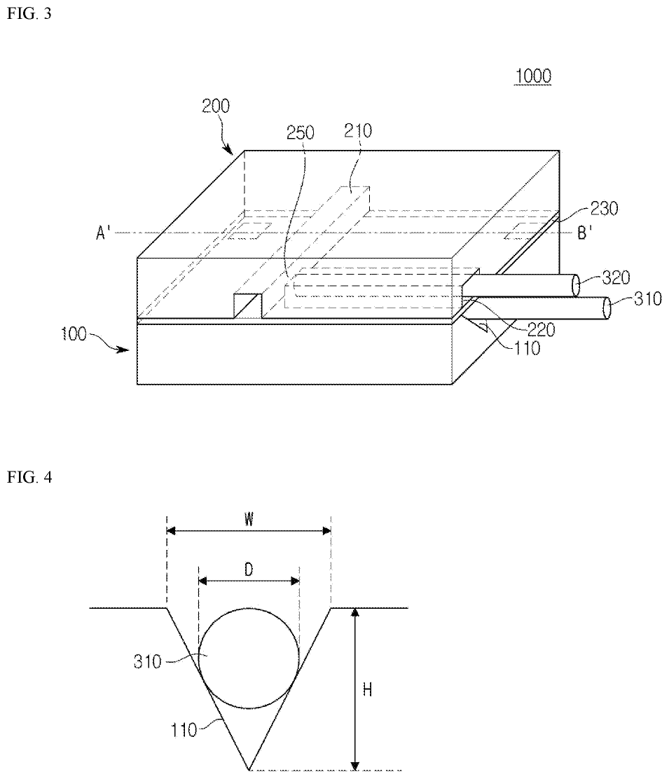

FIG. 1 is a perspective view illustrating an optofluidic droplet fluorescence measuring device according to an embodiment of the present disclosure. FIG. 2 is a view illustrating a process of coupling a fluorescence excitation unit and a fluorescence measurement unit in a device of the present disclosure. FIG. 3 is a perspective view illustrating a fluorescence excitation unit and a fluorescence measurement unit coupled to each other in a device of the present disclosure.

Referring to FIG. 1 to FIG. 3, a optofluidic droplet fluorescence measuring device 1000 of the present disclosure includes a fluorescence excitation unit 100 and a fluorescence measurement unit 200.

The fluorescence excitation unit 100 is a configuration means to provide fluorescence-exciting light to optofluidic droplets that flow into the fluorescence measurement unit 200, including an excitation channel 110, into which an optical fiber 310 for applying fluorescence-exciting light is inserted, a reflection means 120 that is formed at an end (or end face) of the excitation channel 110, reflects fluorescence-exciting light upwards to output the light to the fluorescence measurement unit 200 formed above, and a first coupling unit 130 for coupling the fluorescence measurement unit 200 and the fluorescence excitation unit 100 in alignment by being coupled with a second coupling unit 240 formed in the fluorescence measurement unit 200.

The excitation channel 110 is formed by etching (e.g., wet etching) some areas of a substrate, and the optical fiber 310 for providing fluorescence-exciting light is inserted into the excitation channel 110.

Herein, the substrate may include a silicon substrate and may include not only a silicon substrate but also every type of semiconductor substrates to which the device of the present disclosure is applicable. Of course, when the substrate is not a semiconductor substrate, the excitation channel 110 may be formed by injection or molding.

As illustrated in FIG. 4, the excitation channel 110 may have its depth and width determined by the optical fiber 310 inserted in the excitation channel 110. For example, the width (W) and depth (height, H) of the excitation channel 110 may be determined by a diameter (D) of the optical fiber 310 inserted into the excitation channel 110, and as an example, when the optical fiber 310 has a diameter of 125 um, the width (W) of the excitation channel may be 242 um. Of course, such a condition may be determined by an etching condition according to a diameter of an optical fiber, and such an etching condition according to a diameter of an optical fiber may be determined by an individual person or a service provider that provides a device of the present disclosure.

FIG. 4 illustrates an example of the excitation channel 110 formed in ‘V’ shape, but the shape of the excitation channel 110 is not constrained or limited to V shape (V-groove) and may be formed in various shapes that enable an optical fiber to be inserted into the excitation channel 110. For example, the excitation channel 110 may be formed in a ‘□’ shape and may also be formed in an inverted pentagon shape. Of course, such a shape of the excitation channel 110 may also be determined by an individual person or a service provider that provides a device of the present disclosure.

Furthermore, the excitation channel 110 may be formed to have a predetermined angle, for example, an angle of 45 degrees or above, and the reflection means 120 may be formed on an end face of the excitation channel 110 that is formed at such a predetermined angle.

As described above, the reflection means 120 is a configuration means that is formed in a predetermined area including an end (end face) of the excitation channel 110, which is formed at a predetermined angle, and reflects fluorescence-exciting light emitted (or applied) from the optical fiber 310 inserted in the excitation channel 110 upwards to a fluidic channel 210 of the fluorescence measurement unit 200, and the reflection means 120 is formed in a predetermined upper region of the excitation channel 110.

Herein, the reflection means 120 may be formed in the predetermined upper region, including the end of the excitation channel 110, through metal deposition using a mask, for example, a shadow mask. The reflection means 120 may be formed in a predetermined thickness by deposition using at least one metal including aluminum (Al), gold (Au), silver (Ag) and copper (Cu) and may be formed to have a thickness, for example, equal to or greater than 200 nm.

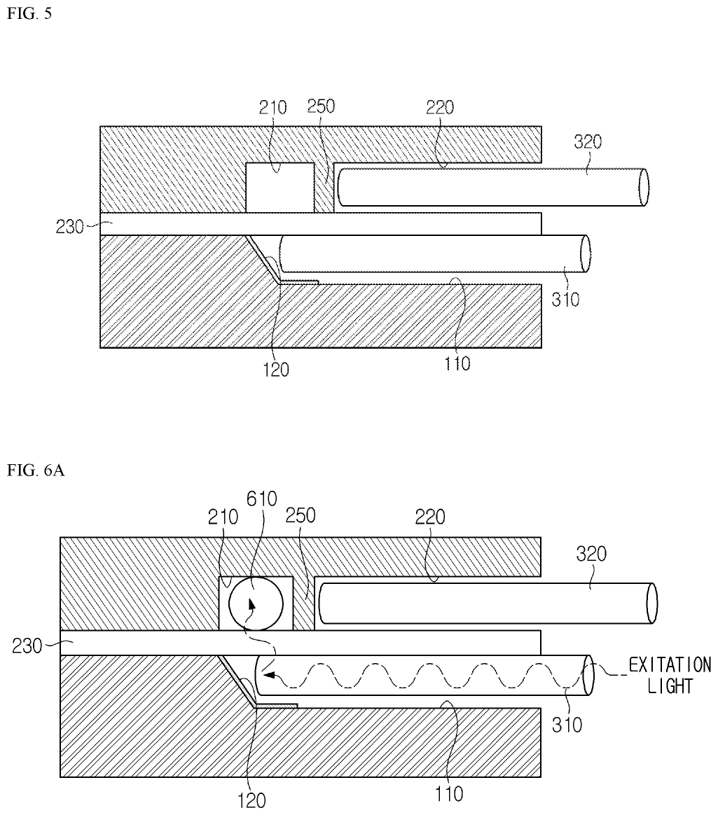

For example, as illustrated in FIG. 5, the reflection means 120 may be formed on an end face of the excitation channel 110 and a predetermined region of the excitation channel 110 adjacent to the end face and thus may provide fluorescence-exciting light emitted from the optical fiber 310 upwards to the fluidic channel 210 of the fluorescence measurement unit 200 through reflection using an inclined angle of the end face.

According to an embodiment, when a substrate is silicon substrate, a predetermined region including the end face of the excitation channel 110 may function as a reflection means. For example, as a silicon substrate has a clean surface so that the end face of the excitation channel 110, which is formed to have a predetermined angle, can reflect fluorescence-exciting light, the end face of the excitation channel 110 may be used as the reflection means 120.

The first coupling unit 130 is formed to have a corresponding shape to a shape of the second coupling unit 240 and is formed in a position corresponding to a position of the second coupling unit 240. For example, when the second coupling unit 240 is formed in a convex shape, the first coupling unit 130 may be formed in a concave shape.

Herein, the first coupling unit 130 may be formed in at least one or more regions of an upper portion of a substrate. According to an embodiment, when the substrate is a semiconductor substrate, the first coupling unit 130 may be formed in at least one or more regions by precisely etching a region where the first coupling unit 130 is to be formed.

The fluorescence measurement unit 200 is a configuration means to measure fluorescence that is generated from an optofluidic droplet by fluorescence-exciting light input from the fluorescence excitation unit 100, including a fluidic channel 210 for inputting an optofluidic droplet, an optical channel 220 in which the optical fiber 320 for receiving fluorescence from the optofluidic droplet is inserted, a spacer 230 that is formed between the fluorescence measurement unit 200 and the fluorescence excitation unit 100 and maintain a predetermined space between the fluorescence measurement unit 200 and the fluorescence excitation unit 100, and the second coupling unit 240 that is coupled with the first coupling unit 130 formed in the fluorescence excitation unit 100 to couple the fluorescence measurement unit 200 and the fluorescence excitation unit 100 in alignment. Herein, the fluorescence measurement unit 200 may be formed by polydimethylsiloxane (PDMS) and may also be formed by a material obtained through molding or injection. Of course, the fluorescence measurement unit 200 is not constrained or limited to being formed by the above-described material but may be formed by any material and manufacturing method capable of manufacturing the fluorescence measurement unit 200. For example, the fluorescence measurement unit 200 may form a channel layer for forming the fluidic channel 210 and the optical channel 220 in an upper portion of a first substrate, form a PDMS layer in a predetermined thickness in an upper portion of the first substrate including the channel layer, and then fabricate the fluorescence measurement unit 200 including the fluidic channel 210 and the optical channel 220 by separating the PDMS layer from the first substrate.

The fluidic channel 210 is a channel (passage) in which an optofluidic droplet and oil are input and flow through, and may be formed in a vertical direction to a direction of the excitation channel 110. Herein, a part of the fluidic channel 210 may be formed to meet an end part of the excitation channel 110, and in an embodiment, a position of one sidewall (e.g., a left sidewall) of the fluidic channel 210, which is a part, for example, may be formed to meet the end position of the excitation channel 110. Of course, the position of one sidewall of the fluidic channel 210, which a part, should not necessarily correspond to the end position of the excitation channel 110 but preferably needs to be formed in a position range in which fluorescence-exciting light of the fluorescence excitation unit 100 can be well received from a part of the excitation channel 110.

The optical channel 220 is formed to cross perpendicularly to the fluidic channel 210 and is formed to be spaced at a predetermined distance from the fluidic channel 210 by means of a partition 250. Herein, the width and depth of the optical channel 220 may be determined by a diameter of the optical fiber 320 that is inserted into the optical channel 220. The partition 250 between the optical channel 220 and the fluidic channel 210 may have a thickness and transmittance, which fluorescence generated by an optofluidic droplet can pass to the optical channel 220, and, for example, may have a thickness of 100 to 150 um.

The spacer 230 helps to form an empty space between the fluidic channel 210 and the optical channel 220 and is formed by a material with a predetermined level or above of transmittance so that it transmits and delivers a fluorescence-exciting light reflected by the reflection means 120 of the fluorescence excitation unit 100 to the fluidic channel 210.

Herein, the spacer 230 may be formed with glass, quartz and other materials with a high level of transmittance.

The spacer 230 blocks an open bottom area of the fluidic channel 210 and the optical channel 220 so that an optofluidic droplet and oil can move through the fluidic channel 210, and also helps the optical fiber 320 inserted into the optical channel 220.

The second coupling unit 240 is formed under or at the bottom of the spacer 230 and is coupled with the first coupling unit in alignment, thereby coupling the fluorescence measurement unit 200 and the fluorescence excitation unit 100 in alignment.

Herein, the second coupling unit 240 is formed to have a corresponding shape to a shape of the first coupling unit 130 and may be formed in a position corresponding to a position of the first coupling unit 130. For example, when the first coupling unit 130 is formed in a concave shape, the second coupling unit 240 may be formed in a convex shape.

As described above, the fluorescence excitation unit 100 and the fluorescence measurement unit 200 may implement a device of the present disclosure by being coupled in alignment through the first coupling unit 130 and the second coupling unit 240. According to an embodiment, as for a method of alignment-coupling, the first coupling unit 130 and the second coupling unit 240 are detected and recognized by means of a marker through image processing, and the fluorescence excitation 100 and the fluorescence measurement unit 200 may be coupled in alignment by using the detection and recognition of the marker. Furthermore, the device of the present disclosure may be implemented by applying various methods capable of coupling the fluorescence excitation unit 100 and the fluorescence measurement unit 200 in alignment.

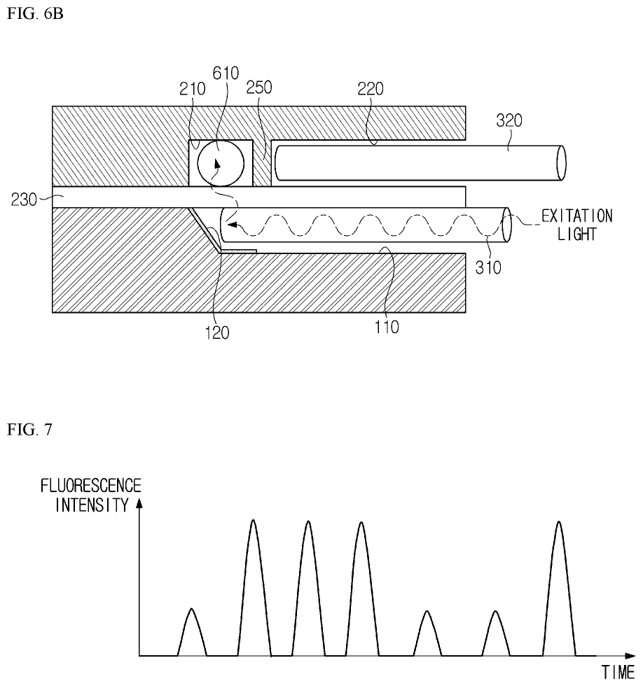

FIG. 5 is a view illustrating A′-B′ of FIG. 3 in section. FIG. 6 is a view for describing an operation of an optofluidic droplet fluorescence measuring device of the present disclosure. FIG. 6A is a view for describing a case in which an optofluidic droplet is a PCR− droplet, and FIG. 6B is a view for describing a case in which an optofluidic droplet is a PCR+ droplet.

As for an operation of the device of the present disclosure, referring to FIG. 5 and FIG. 6, the device 1000 of the present disclosure may measure fluorescence of an optofluidic droplet that flows into through the fluidic channel 210, by being implemented as the fluorescence excitation unit 100 and the fluorescence measurement unit 200 are coupled by the first coupling unit 130 and the second coupling unit 240. Referring to FIG. 6A, when an optofluidic droplet flowing into the fluidic channel 210 is a PCR-droplet, fluorescence-exciting light, which excites fluorescence to the optical fiber 310 inserted into the excitation channel 110 of the fluorescence excitation unit 100, moves left and is delivered upwards to a part (or predetermined region) of the fluidic channel 210 through the reflection means 120. When the fluorescence-exciting light delivered to the fluidic channel 210 meets a PCR− droplet 610 with imperfect amplification or without a target biomaterial, since the PCR− droplet 610 does not generate fluorescence and no fluorescence moves to the optical fiber 320 inserted into the optical channel 220, no electric signal occurs in a photodetector prepared at the end of the optical fiber 320.

Referring to FIG. 6B, when an optofluidic droplet flowing into the fluidic channel 210 is a PCR+ droplet, fluorescence-exciting light, which excites fluorescence to the optical fiber 310 inserted into the excitation channel 110 of the fluorescence excitation unit 100, moves left and is delivered upwards to a part of the fluidic channel 210 through the reflection means 120. When the fluorescence-exciting light delivered to the fluidic channel 210 meets a PCR+ droplet 620 with perfect amplification, the PCR+ droplet 620 generates fluorescence, and the generated fluorescence moves along the optical fiber 320 inserted into the optical channel 220, and then an electric signal occurs in a photodetector prepared at the end of the optical fiber 320.

As illustrated in FIG. 7, an electric signal detected by the photodetector may measure fluorescence intensity of an optofluidic droplet, that is, a PCR+ droplet flowing into the fluidic channel 210, so that a PCR test can be accurately performed.

The above device of the present disclosure is described to be formed by the fluidic channel 210 and the optical channel 220 crossing perpendicularly to each other and to form only one optical channel, but the optical channel 220 is not constrained or limited to being formed by crossing the fluidic channel 210 perpendicularly but may be formed to have a predetermined angle, and not one but multiple optical channels may be formed.

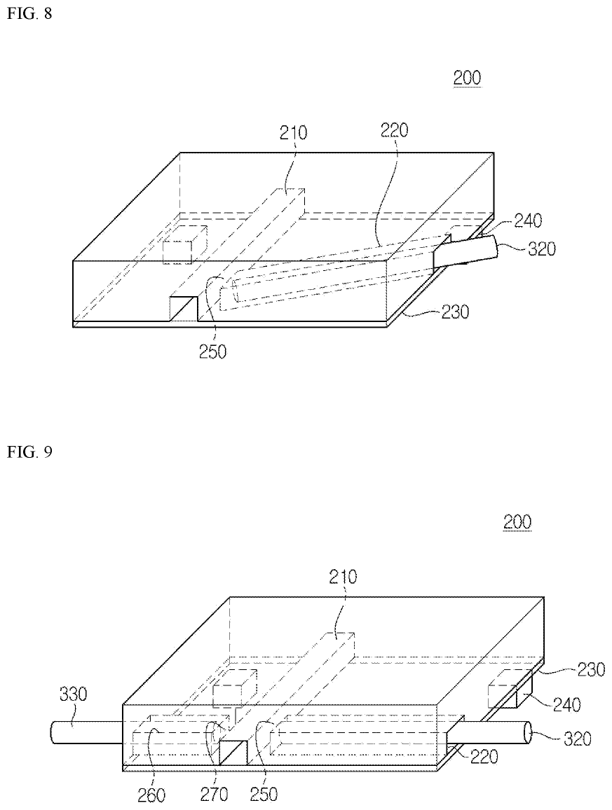

According to an embodiment, as illustrated in FIG. 8, in the device of the present disclosure, the optical channel 220 of the fluorescence measurement unit 200 may not be formed to cross the excitation channel 210 perpendicularly but to have a predetermined angle. That is, when an end of the optical channel 220, which constitutes the fluorescence measurement unit 200, is formed in a part of the fluidic channel 210, the optical channel 220 may be formed not to cross the fluidic channel 210 perpendicularly but to have a predetermined angle. Herein, an angle between the fluidic channel 210 and the optical channel 220 may be determined by an individual person or a service provider presenting the present disclosure, and it may be determined by considering the accuracy of fluorescence measurement, miniaturization of device, organic relationship with another configuration, a process, and the like.

According to another embodiment, as illustrated in FIG. 9, in a device of the present disclosure, an optical channel of the fluorescence measurement unit 200 may include a first optical channel 220, which is formed by crossing a part of the fluidic channel 210 perpendicularly, and a second optical channel 260 that is formed by crossing a part of the fluidic channel 210 perpendicularly and is formed in an opposite direction (e.g., left direction) to a direction (e.g., right direction) of the first optical channel 220. Herein, the optical fiber 330 for receiving fluorescence generated from the fluidic channel 210 may be inserted into the second optical channel 260, and the second optical channel 260 may be formed to be spaced at a predetermined distance from the fluidic channel 210 through the partition 270. The partition between the first optical channel 220 and the fluidic channel 210 and the partition 270 between the second optical channel 260 and the fluidic channel 210 may have a same thickness. That is, the first optical channel 220 may be formed to cross the right side of the fluidic channel 210 perpendicularly, and the second optical channel 260 may be formed to cross the left side of the fluidic channel 210 perpendicularly, so that, when fluorescence is generated from an optofluidic droplet, fluorescence proceeds along the optical fiber 320 inserted in the first optical channel 220 and along the optical fiber 330 inserted in the second optical channel 260, and thus an electric signal corresponding to the fluorescence may be detected through a photodetector connected to the two optical fibers 320 and 330. FIG. 9 illustrates the two optical channels 220 and 260 crossing the fluidic channel 210 perpendicularly but is not constrained or limited thereto, and the two optical channels may be formed to have a predetermined angle with the fluidic channel 210 as illustrated in FIG. 8.

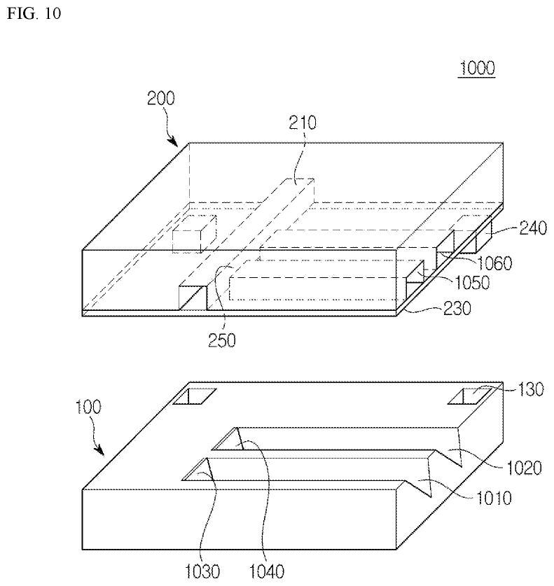

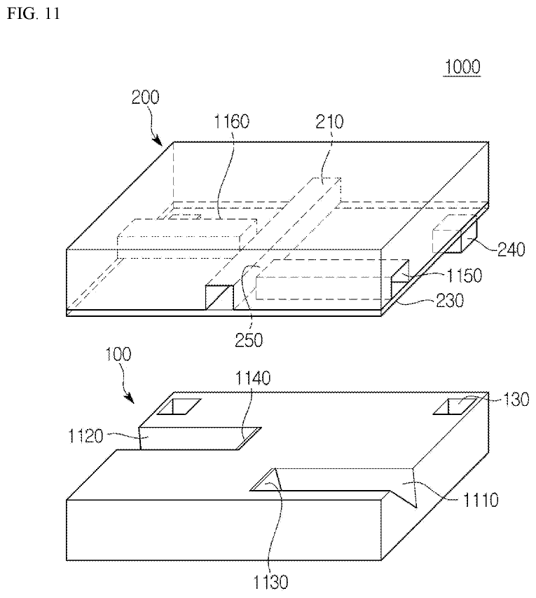

Furthermore, a device of the present disclosure may use not only one fluorescence-exciting light but also fluorescence-exciting lights with different wavelengths to measure fluorescence corresponding to each of the fluorescence-exciting lights with different wavelengths. According to an embodiment, in the device 1000 of the present disclosure, as illustrated in FIG. 10, a first excitation channel 1010 and a second excitation channel 1020 are formed in parallel in the fluorescence excitation unit 100 in order to emit two fluorescence-exciting lights with different wavelengths, and respective reflection means 1030 and 1040 are formed in partital regions including end faces of the first excitation channel 1010 and the second excitation channel 1020, so that a fluorescence-exciting light of each wavelength emitted through an optical fiber inserted in the respective excitation channels 1010 and 1020 is delivered upwards to the fluidic channel 210. Herein, as a fluorescence-exciting light of a first wavelength is delivered to a first region of the fluidic channel 210 and a fluorescence-exciting light of a second wavelength is delivered to a second region of the fluidic channel 210, fluorescence generated in the first region proceeds along an optical fiber of the optical channel 1050, which crosses the first region perpendicularly, and fluorescence generated in the second region proceeds along an optical fiber of the optical channel 1060, which crosses the second region perpendicularly, and thus an electric signal is generated from or detected in each photodetector connected to an optical fiber of each of the optical channels 1050 and 1060.

FIG. 10 illustrated that the two excitation channels 1010 and 1020 and the two optical channels 1050 and 1060 are formed in parallel, but the two excitation channels 1010 and 1020 and the two optical channels 1050 and 1060 may not be formed in parallel but be formed to cross perpendicularly to each other. For example, as illustrated in FIG. 11, a first excitation channel 1110 may be formed to enable a fluorescence-exciting light of a first wavelength to be emitted from right to left, a second excitation channel 1120 may be formed to enable a fluorescence-exciting light of a second wavelength to be emitted from left to right, and a first optical channel 1150 and a second optical channel 1160 may also be formed to cross each other like the first excitation channel 1110 and the second excitation channel 1120.

Likewise, two excitation channels may be formed in parallel, while two optical channels may be formed to cross each other, and two excitation channels may be formed to cross each other, while two optical channels may be formed in parallel. These channel forming methods may be combined in various ways. Of course, a device of the present disclosure is not constrained or limited to two excitation channels and two optical channels but may form two or more excitation channels and two or more optical channels so that a plurality of fluorescence corresponding to different wavelengths can be generated and detected through each of a plurality of fluorescence-exciting lights with different wavelengths.

Thus, a device according to embodiments of the present disclosure may provide a droplet fluorescence measuring device for measuring fluorescence properties of unit droplets, after polymerase chain reaction in digital PCR, for example, droplet digital PCR (ddPCR), thereby checking the presence of biomaterial (DNA or RNA) precisely and accurately.

In addition, a device according to embodiments of the present disclosure may measure a fluorescence property of a droplet in ddPCR by using a flat optical fiber technology, thereby improving measurement accuracy and miniaturizing a measurement device.

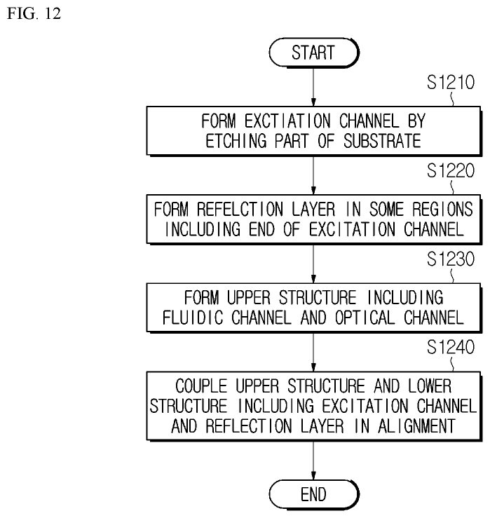

FIG. 12 is a view illustrating a flowchart of a manufacturing method for an optofluidic droplet fluorescence measuring device according to an embodiment of the present disclosure. FIG. 12 is a view conceptually illustrating a process of manufacturing an optofluidic droplet fluorescence measurement device of FIG. 1 to FIG. 11.

Referring to FIG. 12, a method for manufacturing an optofluidic droplet fluorescence measurement device includes forming a lower structure corresponding to the fluorescence excitation unit 100 (S1210, S1220), forming an upper structure corresponding to the fluorescence measurement unit 200 (S1230), and coupling the lower structure and the upper structure in alignment in order to manufacture the optofluidic droplet fluorescence measurement device (S1240).

Specifically, the method of the present disclosure forms an excitation channel in a horizontal direction by etching a substrate, for example, a silicon substrate and forms a reflection layer at the end (or on an end face) of the excitation channel and in partital regions of the excitation channel adjacent to the end (S1210, S1220).

Herein, the step S1210 is a process of forming only one excitation channel, and when fluorescence-exciting lights with different wavelengths are used, a plurality of excitation channels may be formed. The step S1220 forms a reflection layer performing a reflecting function through metal deposition using a shadow mask in an upper portion of the substrate where the excitation channel is formed and may form a reflection layer with a predetermined thickness through deposition using at least one metal including Al, Au, Ag, and Cu.

Furthermore, in the steps of forming the lower structure corresponding to the fluorescence excitation unit 100 (S1210, S1220), a process of forming a coupling means, for example, a concave unit for coupling with the upper structure in at least one region in the upper portion of the substrate may further be performed.

The step S1230 of forming the upper structure corresponding to the fluorescence measurement unit 200 may form a convex channel layer for forming a fluidic channel and an optical channel in an upper portion of a substrate, for example, a silicon substrate, form a PDMS layer with a predetermined thickness in an upper portion of a first substrate including the channel layer, and then form the upper structure corresponding to the fluorescence measurement unit by separating the PDMS layer from the first substrate. Herein, depending on a situation, the PDMS layer may be easily separated from the first substrate by forming the PDMS layer after preprocessing the upper portion of the first substrate including the channel layer.

Furthermore, in the step S1230, a spacer may be formed between the upper structure and the lower structure to maintain a predetermined space between the upper structure and the lower structure, and a coupling means, for example, a convex unit may be formed in the lower part of the spacer for aligned coupling with the lower structure. The spacer and the convex unit thus formed may be coupled with the upper structure, thereby forming the ultimate upper structure.

The step S1240 may manufacture the optofluidic droplet fluorescence measurement device by coupling the upper structure and the lower structure formed through the above-described process, that is, by coupling the concave unit and the convex unit in alignment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A device for measuring optofluidic droplet fluorescence, the device comprising:
a fluorescence excitation unit configured to reflect and output a fluorescence-exciting light, which is applied in a horizontal direction, in an upward direction; and
a fluorescence measurement unit that is physically coupled with the fluorescence excitation unit and receives the fluorescence and measures fluorescence of the optofluidic droplet when fluorescence is generated from an optofluidic droplet by the fluorescence-exciting light that is input from downward direction.

2. The device of claim 1, wherein the fluorescence excitation unit comprises:
an excitation channel into which a first optical fiber for applying the fluorescence-exciting light is inserted by etching at least a part of a substrate; and
a reflection means that is formed at an end of the excitation channel and reflects the fluorescence-exciting light in an upward direction.

3. The device of claim 2, wherein the excitation channel is formed in a ‘V’ shape.

4. The device of claim 2, wherein the reflection means is formed in part of regions including an end of the excitation channel that has a predetermined angle.

5. The device of claim 2, wherein a width and a depth of the excitation channel are determined by a diameter of the first optical fiber.

6. The device of claim 2, wherein the fluorescence excitation unit comprises a first coupling unit that is formed in at least one region of the substrate, and
wherein the fluorescence measurement unit comprises a second coupling unit that is formed at a position corresponding to the first coupling unit and with a shape corresponding to a shape of the first coupling unit so that the fluorescence measurement unit is capable of being physically coupled with the fluorescence excitation unit.

7. The device of claim 1, wherein the fluorescence measurement unit further comprises:
a fluidic channel in which the optofluidic droplet flows; and
a first optical channel that is formed by being spaced at a predetermined distance from the fluidic channel by a first partition, a second optical fiber for receiving fluorescence generated from the optofluidic droplet being inserted into the first optical channel.

8. The device of claim 7, wherein the first optical channel is formed in a orthogonal direction to a part of the fluidic channel into which the fluorescence-exciting light is input.

9. The device of claim 7, wherein the fluorescence measurement unit further comprises a second optical channel that is formed by being spaced at a predetermined distance from the fluidic channel by a second partition, a third optical fiber for receiving fluorescence generated from the optofluidic droplet being inserted into the second optical channel.

10. The device of claim 9, wherein the first optical channel and the second optical channel are formed to have a predetermined angle in different directions with respect to the fluidic channel.

11. The device of claim 7, further comprising a spacer that is formed between the fluorescence measurement unit and the fluorescence excitation unit and maintains a predetermined space between the fluorescence measurement unit and the fluorescence excitation unit.

12. A device for measuring optofluidic droplet fluorescence, the device comprising:
a fluorescence excitation unit configured to reflect and output in an upward direction each of fluorescence-exciting lights with different wavelengths, which are applied respectively in a horizontal direction; and
a fluorescence measurement unit that a fluorescence-exciting light with a wavelength corresponding to each of a plurality of regions of a fluidic channel. which an optofluidic droplet flows, is input into from downward direction, receives fluorescence generated from an optofluidic droplet in each of the plurality of regions and measures the fluorescence of the optofluidic droplet.

13. The device of claim 12, wherein the fluorescence excitation unit comprises:
a plurality of excitation channels into which each optical fiber for applying each of the fluorescence-exciting lights is inserted by etching at least a part of a substrate; and
a plurality of reflection means that are formed at an end of each of the excitation channels and reflect each of the fluorescence-exciting lights in an upward direction.

14. The device of claim 13, wherein the fluorescence measurement unit further comprises:
a fluidic channel in which the optofluidic droplet flows; and
a plurality of optical channels that are formed by being spaced at a predetermined distance from each of a plurality of regions of the fluidic channel by a partition, each optical fiber for receiving fluorescence generated from the optofluidic droplet being inserted into the plurality of optical channels.

15. The device of claim 12, further comprising a spacer that is formed between the fluorescence measurement unit and the fluorescence excitation unit and maintains a predetermined space between the fluorescence measurement unit and the fluorescence excitation unit.

16. The device of claim 13, wherein the plurality of excitation channels is perpendicular to the fluidic channel and are formed in parallel in one side direction of the fluidic channel or are formed to cross each other in one side direction and in another side direction respectively for the fluidic channel.

17. The device of claim 14, wherein the plurality of optical channels is perpendicular to the fluidic channel and are formed in parallel in one side direction of the fluidic channel or are formed to cross each other in one side direction and in another side direction respectively for the fluidic channel.

18. A method for manufacturing an optofluidic droplet fluorescence measurement device, the method comprising:
forming a first structure by forming an excitation channel, into which a first optical fiber for applying a fluorescence-exciting light is inserted by etching at least a part of a substrate, and by depositing, in at least part of regions including an end of the excitation channel, a reflection layer for reflecting the fluorescence-exciting light in an upward direction;
forming a second structure that includes a fluidic channel, in which an optofluidic droplet flows, and an optical channel into which a second optical fiber for receiving fluorescence generated from the optofluidic droplet is inserted; and
coupling the first structure and the second structure in alignment.

19. The method of claim 18, wherein the forming of the second structure comprise:
forming a channel layer for forming the fluidic channel and the optical channel on a first substrate;
forming a polydimethylsiloxane (PDMS) layer with a predetermined thickness on the first substrate including the channel layer; and
forming the second structure by separating the PDMS layer from the first substrate.

20. The method of claim 19, wherein the coupling in alignment couples the first structure and the second structure in alignment by using a spacer for maintaining a predetermined space between the first structure and the second structure.
